(19) United States
(12) Patent Application Publication
(10) Pub. No.: US 2023/0403406 A1
(43) Pub. Date: Dec. 14, 2023

(54) MOTION CODING USING A GEOMETRICAL MODEL FOR VIDEO COMPRESSION

(71) Applicant: InterDigital CE Patent Holdings, SAS, Paris (FR)

(72) Inventors: Philippe Bordes, Laille (FR); Franck Galpin, Thorigne-Fouillard (FR); Antoine Robert, Mézières sur Couesnon (FR); Karam Naser, Mouazé (FR)

(21) Appl. No.: 18/030,699

(22) PCT Filed: Sep. 21, 2021
(86) PCT No.: PCT/EP2021/075972

§ 371 Date: Apr. 6, 2023

(30) Foreign Application Priority Data
Oct. 6, 2020 (EP) 20306161.9

(51) Int. Cl. H04N 19/517; H04N 19/137; H04N 19/597; H04N 19/176

(52) U.S. Cl. CPC H04N 19/517; H04N 19/176; H04N 19/597; H04N 19/137

(57) ABSTRACT

A video coding system performs motion prediction based on epipolar geometry. A first camera corresponds to a current frame, a second camera corresponds to a reference frame and epipolar geometry is used to determine motion parameters allowing to perform a prediction between the reference frame and the current frame.

### TECHNICAL FIELD

At least one of the present embodiments generally relates to motion coding for video using a geometrical model and for example in the context of rendered synthetic video for cloud gaming.

### BACKGROUND

To achieve high compression efficiency, image and video coding schemes usually employ prediction and transform to leverage spatial and temporal redundancy in the video content. Generally, intra or inter prediction is used to exploit the intra or inter frame correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

Cloud gaming uses video coding to convey the game action to the user. Indeed, in such context, the 3D environment of the game is rendered on a server, video encoded and provided to the decoder as a video stream. The decoder displays the video and, in response, transmits user input back to the server, thus allowing the interaction with the game elements and/or other users.

### SUMMARY

At least one of the present embodiments relates to a video coding system that performs motion prediction based on epipolar geometry. A first camera corresponds to a current frame, a second camera corresponds to a reference frame and epipolar geometry is used to determine motion parameters allowing to perform a prediction between the reference frame and the current frame.

According to a first aspect of at least one embodiment, a method for decoding a block of pixels of a current frame of a video comprises performing motion prediction based on epipolar geometry, where a first camera corresponds to the current frame, a second camera corresponds to a reference frame and epipolar geometry is used to determine motion parameters allowing to perform a prediction between a block of the reference frame and the block of the current frame.

According to a second aspect of at least one embodiment, a method for encoding a block of pixels of a current frame of a video comprises performing motion prediction based on epipolar geometry, where a first camera corresponds to the current frame, a second camera corresponds to a reference frame and epipolar geometry is used to determine motion parameters allowing to perform a prediction between a block of the reference frame and the block of the current frame

According to a third aspect of at least one embodiment, an apparatus comprises a decoder for decoding a block of pixels of a current frame of a video, the decoder being configured to perform motion prediction based on epipolar geometry, where a first camera corresponds to the current frame, a second camera corresponds to a reference frame and wherein the decoder is configured to use epipolar geometry to determine motion parameters allowing to perform a prediction between a block of the reference frame and the block of the current frame.

According to a fourth aspect of at least one embodiment, an apparatus comprises an encoder for encoding a block of pixels of a current frame of a video, the encoder being configured to perform motion prediction based on epipolar geometry, where a first camera corresponds to the current frame, a second camera corresponds to a reference frame and wherein the decoder is configured to use epipolar geometry to determine motion parameters allowing to perform a prediction between a block of the reference frame and the block of the current frame.

According to a fifth aspect of at least one embodiment, a computer program comprising program code instructions executable by a processor is presented, the computer program implementing the steps of a method according to at least the first or second aspect.

According to a sixth aspect of at least one embodiment, a computer program product which is stored on a non-transitory computer readable medium and comprises program code instructions executable by a processor is presented, the computer program product implementing the steps of a method according to at least the first or second aspect when executed on a processor.

### BRIEF DESCRIPTION OF THE DRAWINGS

FIG. 1 illustrates a block diagram of an example of video encoder 100. FIG. 2 illustrates a block diagram of an example of video decoder 200. FIG. 3 illustrates a block diagram of an example of a system in which various aspects and embodiments are implemented.

FIG. 4 illustrates an example of a cloud gaming system in which various aspects and embodiments are implemented. FIGS. 5A, 5B, 5C illustrate examples of control points for affine prediction mode. FIG. 6 illustrates an example of symmetrical MVD mode. FIG. 7 illustrates the directions position when using merge mode with MVD.

FIG. 8 illustrates an example of decoder side motion vector refinement. FIG. 9 illustrates an example of simplified model of pinhole camera. FIG. 10 illustrates the principles of epipolar plane and epipolar line. FIG. 11 illustrates an example of motion prediction based on epipolar geometry according to at least one embodiment.

FIG. 12 illustrates an example flowchart to derive motion vector based on epipolar geometry according to at least one embodiment.

FIG. 13 illustrates an example of projection of motion predictor onto the epipolar line.

FIG. 14 illustrates an example flowchart of merge candidates filtering process according to at least one embodiment.

FIG. 15 illustrates an example flowchart for the derivation of motion predictor from stored motion info according to at least one embodiment.

### DETAILED DESCRIPTION

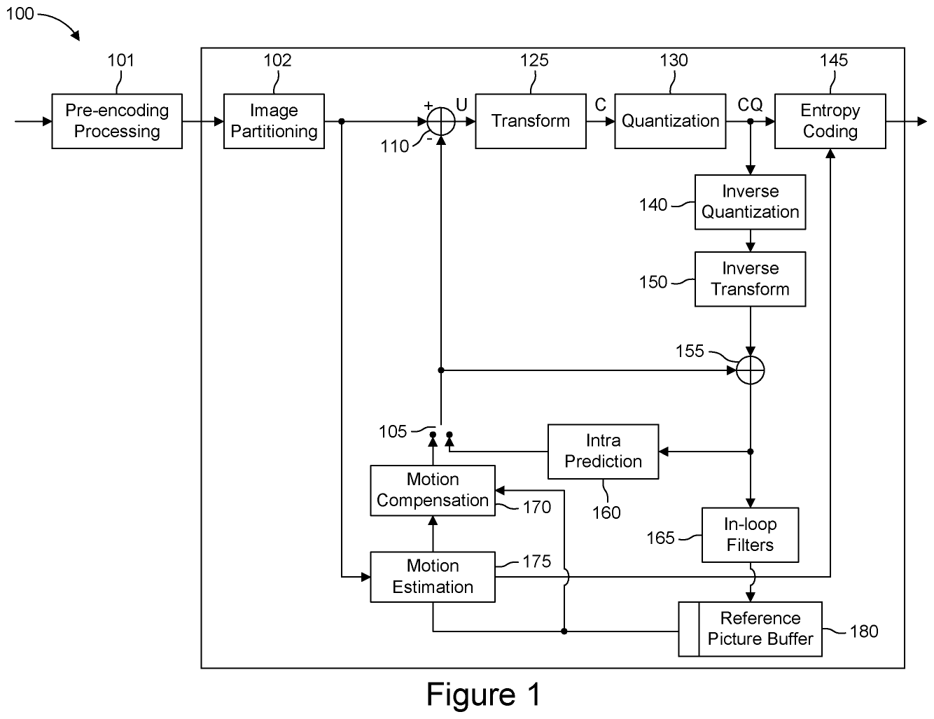

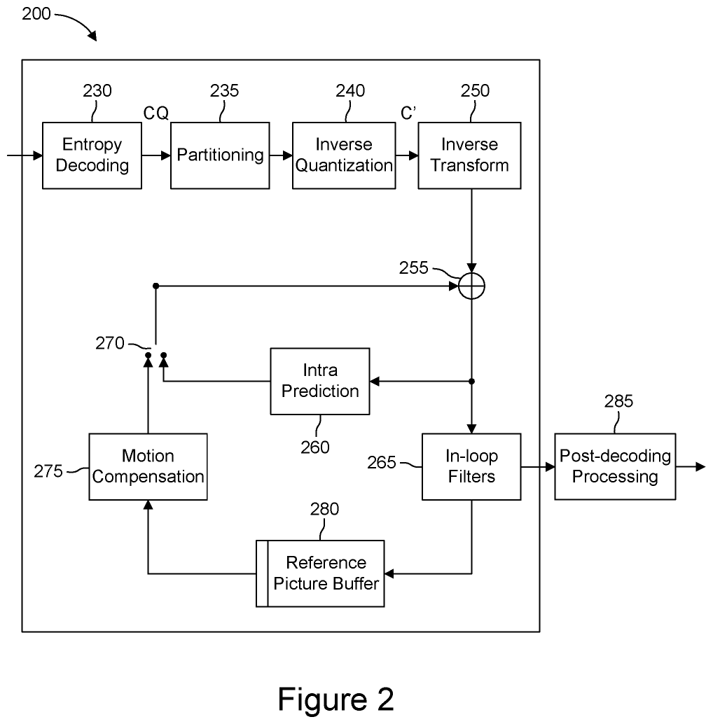

FIG. 1 illustrates block diagram of an example of video encoder 100. Examples of video encoders comprise a High Efficiency Video Coding (HEVC) encoder compliant with the HEVC standard, or a HEVC encoder in which improvements are made to the HEVC standard or an encoder employing technologies similar to HEVC, such as a JEM (Joint Exploration Model) encoder under development by JVET (Joint Video Exploration Team) for Versatile Video Coding (VVC) standardization, or other encoders.

Before being encoded, the video sequence can go through pre-encoding processing (101). This is for example performed by applying a color transform to the input color picture (for example, conversion from RGB 4:4:4 to YCbCr 4:2:0) or performing a remapping of the input picture components in order to get a signal distribution more resilient to compression (for instance using a histogram equalization of one of the color components). Metadata can be associated with the pre-processing and attached to the bitstream.

In HEVC, to encode a video sequence with one or more pictures, a picture is partitioned (102) into one or more slices where each slice can include one or more slice segments. A slice segment is organized into coding units, prediction units, and transform units. The HEVC specification distinguishes between “blocks” and “units,” where a “block” addresses a specific area in a sample array (for example, luma, Y), and the “unit” includes the collocated blocks of all encoded color components (Y, Cb, Cr, or monochrome), syntax elements, and prediction data that are associated with the blocks (for example, motion vectors).

For coding in HEVC, a picture is partitioned into coding tree blocks (CTB) of square shape with a configurable size, and a consecutive set of coding tree blocks is grouped into a slice. A Coding Tree Unit (CTU) contains the CTBs of the encoded color components. A CTB is the root of a quadtree partitioning into Coding Blocks (CB), and a Coding Block may be partitioned into one or more Prediction Blocks (PB) and forms the root of a quadtree partitioning into Transform Blocks (TBs). Corresponding to the Coding Block, Prediction Block, and Transform Block, a Coding Unit (CU) includes the Prediction Units (PUs) and the tree-structured set of Transform Units (TUs), a PU includes the prediction information for all color components, and a TU includes residual coding syntax structure for each color component. The size of a CB, PB, and TB of the luma component applies to the corresponding CU, PU, and TU.

In the present application, the term “block” can be used to refer, for example, to any of CTU, CU, PU, TU, CB, PB, and TB. In addition, the “block” can also be used to refer to a macroblock and a partition as specified in H.264/AVC or other video coding standards, and more generally to refer to an array of data of various sizes. Indeed, in other coding standards, such as the one under development by JVET, the block shapes can be different from square blocks (for example rectangular blocks), the maximal block size can be bigger and the arrangement of blocks can be different.

In the example of encoder 100, a picture is encoded by the encoder elements as described below. The picture to be encoded is processed in units of CUs. Each CU is encoded using either an intra or inter mode. When a CU is encoded in an intra mode, it performs intra prediction (160). In an inter mode, motion estimation (175) and compensation (170) are performed. The encoder decides (105) which one of the intra mode or inter mode to use for encoding the CU and indicates the intra/inter decision by a prediction mode flag. Prediction residuals are calculated by subtracting (110) the predicted block from the original image block.

CUs in intra mode are predicted from reconstructed neighboring samples within the same slice. A set of 35 intra prediction modes is available in HEVC, including a DC, a planar, and 33 angular prediction modes. The intra prediction reference is reconstructed from the row and column adjacent to the current block. The reference extends over two times the block size in the horizontal and vertical directions using available samples from previously reconstructed blocks. When an angular prediction mode is used for intra prediction, reference samples can be copied along the direction indicated by the angular prediction mode.

The applicable luma intra prediction mode for the current block can be coded using two different options. If the applicable mode is included in a constructed list of three most probable modes (MPM), the mode is signaled by an index in the MPM list. Otherwise, the mode is signaled by a fixed-length binarization of the mode index. The three most probable modes are derived from the intra prediction modes of the top and left neighboring blocks.

For an inter CU, the corresponding coding block is further partitioned into one or more prediction blocks. Inter prediction is performed on the PB level, and the corresponding PU contains the information about how inter prediction is performed. The motion information (for example, motion vector and reference picture index) can be signaled with two methods, namely, “merge mode” and “advanced motion vector prediction (AMVP)”.

In the merge mode, a video encoder or decoder builds a candidate list based on already coded blocks, and the video encoder signals an index for one of the candidates in the candidate list. At the decoder side, the motion vector (MV) and the reference picture index are reconstructed based on the signaled candidate.

In AMVP, a video encoder or decoder builds candidate lists based on motion vectors determined from already coded blocks. The video encoder then signals an index in the candidate list to identify a motion vector predictor (MVP) and signals a motion vector difference (MVD). At the decoder side, the motion vector (MV) is reconstructed as MVP+MVD. The applicable reference picture index is also explicitly coded in the PU syntax for AMVP.

The prediction residuals are then transformed (125) and quantized (130), including at least one embodiment for adapting the chroma quantization parameter described below. The transforms are generally based on separable transforms. For instance, a DCT transform is first applied in the horizontal direction, then in the vertical direction. In recent codecs such as the JEM, the transforms used in both directions may differ (for example, DCT in one direction, DST in the other one), which leads to a wide variety of 2D transforms, while in previous codecs, the variety of 2D transforms for a given block size is usually limited.

The quantized transform coefficients, as well as motion vectors and other syntax elements, are entropy coded (145) to output a bitstream. The encoder may also skip the transform and apply quantization directly to the non-transformed residual signal on a 4×4 TU basis. The encoder may also bypass both transform and quantization, that is, the residual is coded directly without the application of the transform or quantization process. In direct PCM coding, no prediction is applied and the coding unit samples are directly coded into the bitstream.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture, for example, to perform deblocking/SAO (Sample Adaptive Offset) filtering to reduce encoding artifacts. The filtered image is stored at a reference picture buffer (180).

FIG. 2 illustrates a block diagram of an example of video decoder 200. Examples of video decoders comprise a High Efficiency Video Coding (HEVC) decoder compliant with the HEVC standard, or a HEVC decoder in which improvements are made to the HEVC standard or a decoder employing technologies similar to HEVC, such as a JEM (Joint Exploration Model) decoder under development by JVET (Joint Video Exploration Team) for Versatile Video Coding (VVC) standardization, or other decoders.

In the example of decoder 200, a bitstream is decoded by the decoder elements as described below. Video decoder 200 generally performs a decoding pass reciprocal to the encoding pass as described in FIG. 1, which performs video decoding as part of encoding video data.

In particular, the input of the decoder includes a video bitstream, which may be generated by video encoder 100. The bitstream is first entropy decoded (230) to obtain transform coefficients, motion vectors, picture partitioning information, and other coded information. The picture partitioning information indicates the size of the CTUs, and a manner a CTU is split into CUs, and possibly into PUs when applicable. The decoder may therefore divide (235) the picture into CTUs, and each CTU into CUs, according to the decoded picture partitioning information. The transform coefficients are de-quantized (240) including at least one embodiment for adapting the chroma quantization parameter described below and inverse transformed (250) to decode the prediction residuals.

Combining (255) the decoded prediction residuals and the predicted block, an image block is reconstructed. The predicted block may be obtained (270) from intra prediction (260) or motion-compensated prediction (that is, inter prediction) (275). As described above, AMVP and merge mode techniques may be used to derive motion vectors for motion compensation, which may use interpolation filters to calculate interpolated values for sub-integer samples of a reference block. In-loop filters (265) are applied to the reconstructed image. The filtered image is stored at a reference picture buffer (280).

The decoded picture can further go through post-decoding processing (285), for example, an inverse color transform (for example conversion from YCbCr 4:2:0 to RGB 4:4:4) or an inverse remapping performing the inverse of the remapping process performed in the pre-encoding processing (101). The post-decoding processing may use metadata derived in the pre-encoding processing and signaled in the bitstream.

FIG. 3 illustrates a block diagram of an example of a system in which various aspects and embodiments are implemented. System 1000 can be embodied as a device including the various components described below and is configured to perform one or more of the aspects described in this application. Examples of such devices include, but are not limited to, various electronic devices such as personal computers, laptop computers, smartphones, tablet computers, digital multimedia set top boxes, digital television receivers, personal video recording systems, connected home appliances, encoders, transcoders, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or anon-volatile memory device). System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements necessary for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the data stream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the I2C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a Wi-Fi network such as IEEE 802.11. The Wi-Fi signal of these embodiments is received over the communications channel 1060 and the communications interface 1050 which are adapted for Wi-Fi communications. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AV.Link, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs. The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

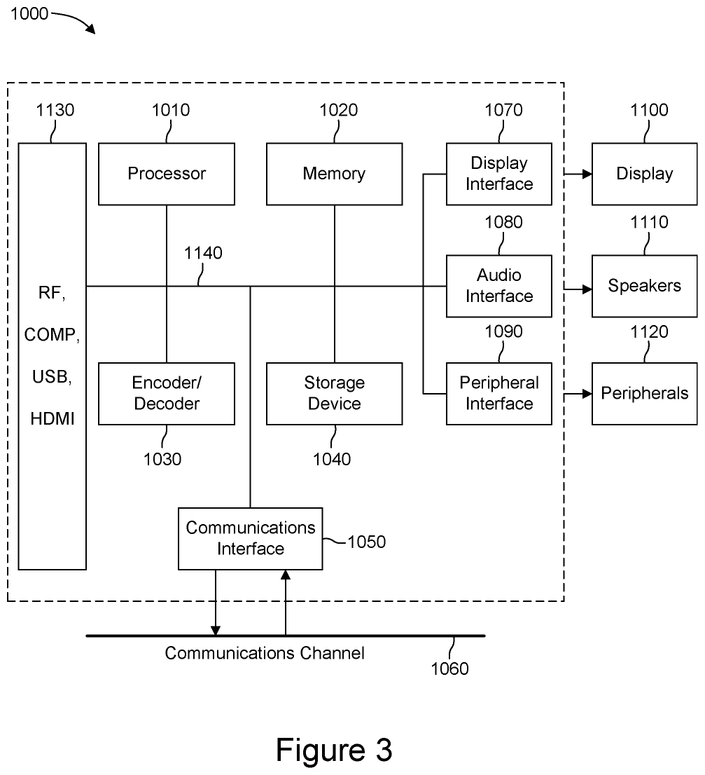

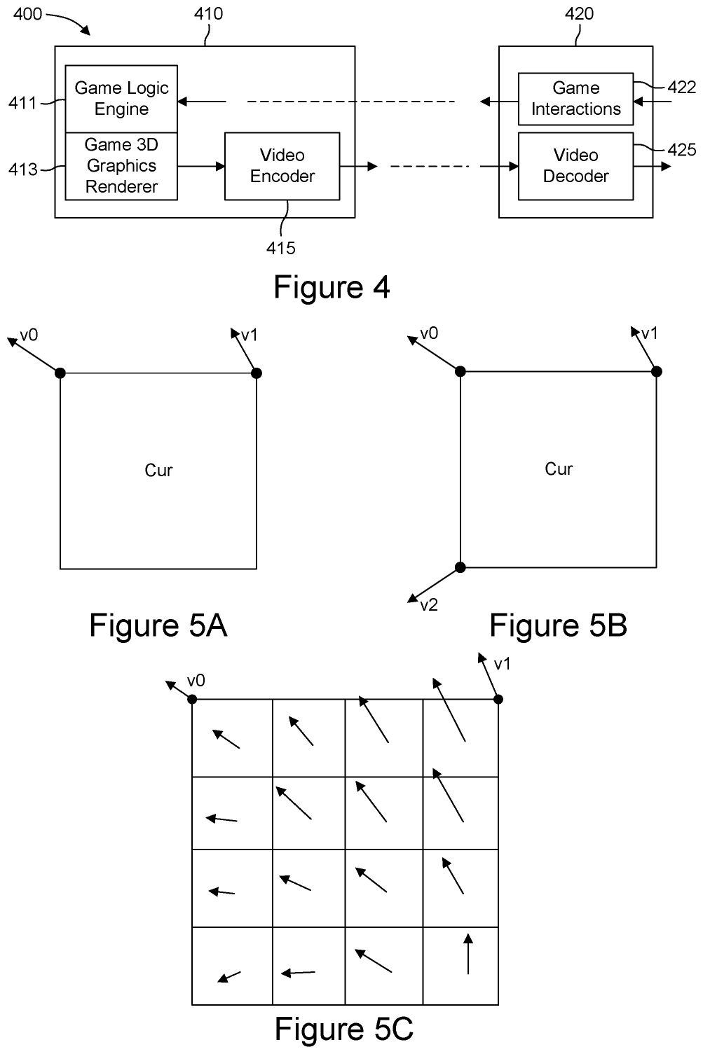

FIG. 4 illustrates an example of a cloud gaming system in which various aspects and embodiments are implemented. In a conventional gaming ecosystem, users possess devices, such as game consoles or computers with high end graphics cards, with sufficient computation capabilities to render 3D virtual environments. Interactions and updates of the environment, thus rendering, is performed locally. Interaction data may be sent to the server to synchronize the virtual environment within multiple players.

A cloud gaming ecosystem is very different in the sense that the rendering hardware resides in the cloud so that the user may use local devices with limited computation capabilities. Thus, the client device may be cheaper or even may be a device already present in the home such as a low-end computer, tablet, low-end smartphone, set top box, television, etc.

In such a system 400, the game engine 411 and the 3D graphics rendering 413, which require costly and power-consuming devices, are hosted by a game server 410 located remotely from the user, for example in the cloud. Next, the rendered frames are encoded by a video encoder 415 and the video stream is transmitted, e.g. through a conventional communication network, to the client device 420 where it may be decoded by a conventional video decoder 425. An additional lightweight module 422 is in charge of managing the user's interactions and frame synchronization and transmitting commands back to the server.

A variant implementation of such system makes use of increasing computation capabilities in devices such as laptops, smartphones, tablets and set top boxes that, in some cases, comprise 3D graphics rendering hardware capabilities. However, these capabilities may not be sufficient to offer high end 3D rendering quality (often requiring significant data memory and 3D graphics rendering power) and can only provide a basic level of rendering. In this case, a hybrid approach can be used to supplement the client graphics basic level rendering by coding an enhanced layer computed as the difference between full capability game rendered images as rendered by a high quality graphics rendering at the server side and the client graphics basic level rendering. This difference is encoded as a video signal by a video encoder module on the server, transmitted through a communication network to the client device, decoded by a video decoder and added as an enhancement layer to the client graphics basic level rendered image.

Cloud gaming systems are thus based on a video encoder such as the one of FIG. 1 and video decoder such as the one of FIG. 2. The encoder and decoder rely on video coding modes that use motion compensation prediction. Some of these modes are described hereunder and may be used according to at least one embodiment.

In inter-prediction, one motion vector and one reference picture index are explicitly coded (AMVP mode) or derived from previously reconstructed CUs (merge mode). The CU prediction is determined based on a motion compensation of blocks in the reference picture. In case of bi-prediction, 2 motion vectors and 2 reference pictures indices are used, 2 motion compensated predictions are determined and combined using a weighting per CU. In case of AMVP a list of motion vector predictors and reference indices is built from previously reconstructed CUs (ex: neighborhood) and an index is coded indicating which one to be used as predictor (MVP). A value MVD is coded and the reconstructed motion vector is MV=MVP+MVD. In case of merge, MVD is not coded (inferred equal to zero). After the CU is reconstructed, the motion vectors and indices may be stored into the motion info buffer, to be used for building motion vector candidates of subsequent CUs and subsequent frames.

FIGS. 5A, 5B, 5C illustrate examples of control points for affine prediction mode. The Affine prediction mode uses 2 (FIG. 5A) or 3 (FIG. 5B) motion vectors as control points (CPMVs) to derive a 4- or 6-parameter motion model to compute motion vectors for each 4×4 subblock in the current block, Cur, as depicted in FIG. 5C.

In affine merge mode, the CPMVs are derived from the MV merge candidates.

FIG. 6 illustrates an example of symmetrical MVD mode. Besides the normal unidirectional prediction and bi-directional prediction mode MVD signaling, where two MVD values (MVD0 and MVD1) and reference indices (lists 0 and 1) are signaled, the symmetric motion vector difference (SMVD) mode allows saving bits by inferring the motion information including reference picture indices of both list-0 and list-1 and MVD of list-1 as follows:
if the nearest reference picture in list-0 and the nearest reference picture in list-1 form a forward and backward pair of reference pictures or a backward and forward pair of reference pictures, SMVD mode can be enabled, and both list-0 and list-1 reference pictures are short-term reference pictures. Otherwise SMVD mode is disabled.
When SMVD is enabled at the current coding unit, the MVD1 value is inferred equal to ‘−MVD0’, in other words, a vector opposite to MVD0 as shown in FIG. 6.

FIG. 7 illustrates the directions position when using merge mode with MVD. In an example implementation based on VVC, in addition to the merge mode where the implicitly derived motion information is directly used for prediction samples generation of the current CU, the merge mode with motion vector differences (MMVD) may be used. In this mode, after a merge candidate is selected, it is further refined by the signaled MVDs information. The MVD is coded with a first index specifying a motion magnitude and a second index indicating the motion direction as depicted in FIG. 7.

Table 1 illustrates an example of correspondence of motion magnitudes using eight index values.

TABLE 1

| | Distance IDX | | | | | | | |
|---|---|---|---|---|---|---|---|---|
| | 0 | 1 | 2 | 3 | 4 | 5 | 6 | 7 |
| Offset (in unit of | ¼ | ½ | 1 | 2 | 4 | 8 | 16 | 32 |
| luma sample) | | | | | | | | |

Table 2 illustrates an example of table listing the motion directions.

TABLE 2

| Direction IDX | 00 | 01 | 10 | 11 |
|---|---|---|---|---|
| x-axis | + | − | N/A | N/A |
| y-axis | N/A | N/A | + | − |

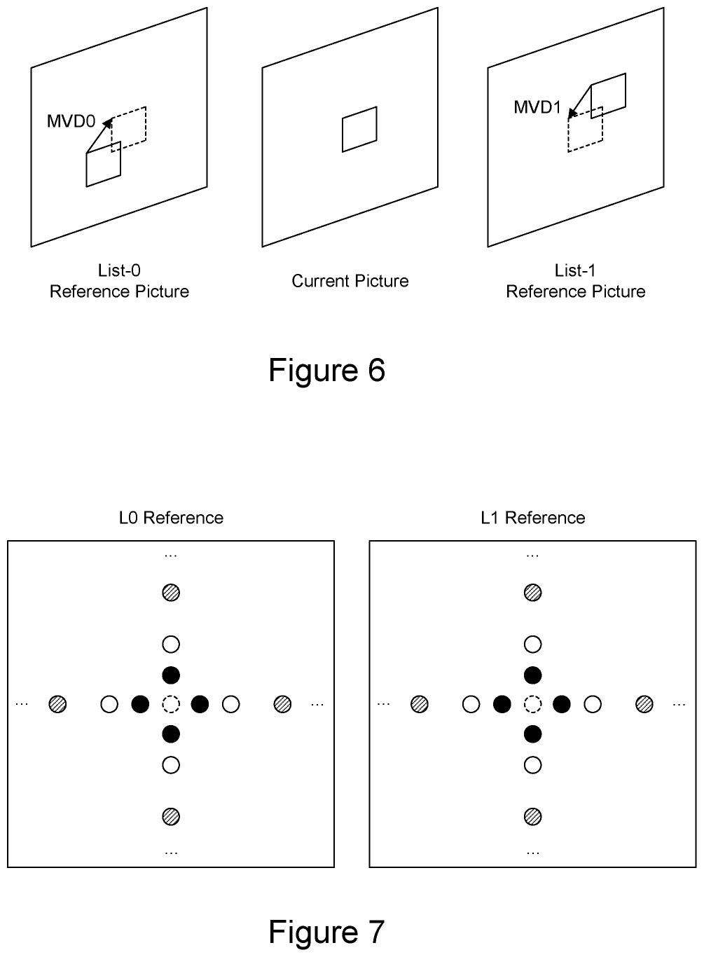

FIG. 8 illustrates an example of decoder side motion vector refinement. In case of bi-prediction merge mode, the motion vectors may be refined through the decoder side motion vector refinement (DMVR) process. Refined motion vectors are searched around the initial motion vectors in the reference picture lists L0 and L1. The method calculates the distortion between the two candidate blocks in the reference picture list L0 and list L1. As illustrated in the figure, the sum of average distance (SAD) between the top-left-to-bottom-right-dashed blocks (810, 811) based on each motion vector candidate around the initial motion vectors (MV0 and MV1) is calculated. The pair of motion vectors candidate with the lowest SAD becomes the refined motion vectors and is used to generate the bi-predicted signal. The motion vector displacement candidate pairs should have symmetric values (mvOffset) around the initial motion vectors.

FIG. 9 illustrates an example of simplified model of pinhole camera. In the context of stereo vision or 3D video processing, epipolar geometry is used to constrain pairing samples in different views of a same static object. When two cameras capture a 3D scene from two distinct positions, there are geometric relations between the 3D points and their projections onto the 2D images that lead to constraints between the image points. Generally, these relations are derived based on the assumption that the cameras can be approximated by the pinhole camera model. The pinhole model allows deriving the pixel position (x,y) in an image of any point P(X,Y,Z) in the scene with the position of the camera optical center C and the virtual image plane. The virtual image plane is defined with its distance to the optical center and its orientation (principal axis in the figure). Thus, “camera parameters” correspond to a parameter set comprising the optical center position coordinates and these virtual image plane parameters.

FIG. 10 illustrates the principles of epipolar plane and epipolar line. Given a point P(X,Y,Z) in the scene and two cameras with respective optical centers C1 and C2, the epipolar plane is defined by the 3 points (P,C1,C2). The projection of the line (C1,P) into the camera C2 draws an epipolar line in the virtual plane of C2.

More generally, in computer vision, the extrinsic parameters K_{E} define a rotation R and translation T of the optical camera which typically may vary with time, while the intrinsic parameters K₁ determine the focal, pixel ratio, skew, optical center distance to the frame plane which are generally constant but may vary in case of zooming for example. In the following, the set of parameters {K_{E}, K₁} is noted {K} and is named camera parameters.

In computer vision, the “fundamental matrix” F is a 3×3 matrix which relates corresponding points in stereo images. F is a function of the extrinsic and intrinsic parameters of the cameras associated with each view and can be determined with K1 and K2 being the camera parameters for each view. For example, F can be determined from extrinsic and intrinsic parameters as:

F=(Q1.R1)^{-T}[t2−t1]ₓ(R2^{T}Q2⁻¹)

where:
[a]ₓ denotes:

$$\\ ( \begin{matrix}0 & - a 3 & a 2 \\ a 3 & 0 & - a 1 \\ - a 2 & a 1 & 0\end{matrix} )$$

The matrix above is the matrix associated with the vector product (cross product) of vector a. This a skew-symmetric matrix and it is noted [a]ₓ.
A^{-T} denotes the transpose of the inverse of a matrix A: A^{-T}=(A⁻¹)^{T}
an intrinsic matrix of a camera C being defined as:

$$\\ Q = ( \begin{matrix}{k}_{u} f & 0 & {k}_{u} {x}_{0} \\ 0 & {k}_{v} f & {k}_{v} {y}_{0} \\ 0 & 0 & 1\end{matrix} )$$

where f is the focal distance, kᵤ and kᵥ are the sampling ratio (horizontal and vertical number of image samples per distance unity in the image respectively) of the camera C, x₀ and y₀ are the coordinates of the lower left corner of the image,

Q1, R1 and t1 are respectively the intrinsic matrix, rotation matrix and the translation of camera C1. Q2, R2 and t2 are respectively the intrinsic matrix, rotation matrix and the translation of camera C2.

A rotation matrix can be expressed, for example, when using Euler angles (α,β,γ)

$$\\ R = ( \begin{matrix}cos γ & - sin γ & 0 \\ sin γ & cos γ & 0 \\ 0 & 0 & 1\end{matrix} ) ( \begin{matrix}cos β & 0 & sin β \\ 0 & 1 & 0 \\ - sin β & 0 & cos β\end{matrix} ) ( \begin{matrix}1 & 0 & 0 \\ 0 & cos α & - sin α \\ 0 & sin α & cos α\end{matrix} )$$

t is the translation of a camera C:

$$\\ t = ( \begin{matrix}tx \\ ty \\ tz\end{matrix} )$$

In epipolar geometry, F(p1) describes the epipolar line on which the corresponding point p2 on the other image must lie. Therefore, for all pairs of corresponding points, the following relation can be used:

p2^{T}.F.p1=0

Embodiments described hereafter have been designed with the foregoing in mind.

In at least one embodiment, a video coding system performs motion prediction based on epipolar geometry. In such embodiment, a first camera corresponds to a current frame, a second camera corresponds to a reference frame and epipolar geometry is used to determine motion parameters allowing to perform a prediction between the reference frame and the current frame.

Such principle is based on the assumption that the objects in the scene are not moving. In the example of a gaming application, it may happen that only few objects are moving between successive frames. The most important movements are the user's movement within the virtual environment. In this case, an epipolar geometry-based video encoding and decoding may be used in a cloud gaming environment. Other domains of application with similar constraints may also use such principle.

In at least one embodiment, a video coding system provides some motion vector candidates derived from additional 3D geometric information of the scene such as camera position or depth of a pixel. In case of gaming content based on rendered synthetic content, such kind of information is easily obtained at the encoder side from the game engine. However, such information could also be extracted from natural (video based) scenes using conventional techniques or dedicated sensors.

One example application relates to cloud gaming based on encoded video of rendered synthetic content but it may apply to more general video coding applications for which, at the encoder side, the depth information, the camera parameters or the fundamental matrix are available.

Depth information may be used to accelerate and improve the coding process. However, in general, the depth information is not available at the decoder side, except in case of cloud gaming with base graphic. In general, the coding of the depth for each samples of the images, even after sub-sampling, is not an acceptable solution because providing such information to the decoder would dramatically increase the bit-rate and jeopardize the coding efficiency.

On the other hand, camera parameters comprising optical center position and image plane orientation or the fundamental matrix which is defined for a set of two cameras (for example one camera for current picture and one camera for a reference picture) is a much smaller item of data that could be encoded in the bitstream once for each image. The camera parameters may be either directly extracted from the virtual environment 3D data or collected at the video record stage or even estimated at the encoder side.

FIG. 11 illustrates an example of motion prediction based on epipolar geometry according to at least one embodiment. A first coding unit is centered in position p1 in the current frame I1. The camera parameters associated with the current frame I1 are K1, while K2 are the camera parameters associated with the reference frame 12. As introduced above, the camera parameters K1 and K2 comprise extrinsic parameters (R=Rotation, T=Translation), intrinsic parameters (focal, pixel ratio, skew, optical center projection position) and other distortion model, if any. p1 corresponds to the projection of a point P somewhere in the scene. This point is assumed not moving and is visible both in both frames. P projects in p1 in frame I1 and p2 in frame I2. The camera parameters K1 and K2 (or the fundamental matrix computed from these parameters) allow deriving the epipolar line in the reference frame, using for example the equations introduced above, where the corresponding point p2 is situated in the reference frame 2 as depicted in FIG. 4.

For the coding in inter mode of the current block located at p1 in the current frame, one needs to know the position of p2 to derive the motion vector mv=p1−p2. Traditionally, when not using epipolar line, two scalar values are necessary to code this vector v (vx;vy). In case the epipolar line is known, only one single value d is required since the motion vector direction is known to be on the epipolar line. In the following, this property will be called “the epipolar geometry constraint”. d may be defined for instance as the signed distance of p2 to a reference point p′2 situated on the epipolar line, where p′2 is computed as the projection of a point P′ belonging to the line (C1,P) situated at arbitrary chosen distance Z from C1.

In a variant embodiment, P′ may be inferred at the decoder side following the following rules:
P′ should be visible in both image planes,
P′ may minimize distance to the optical lines (i.e. line going through Ci and the principal point as shown in FIG. 9).

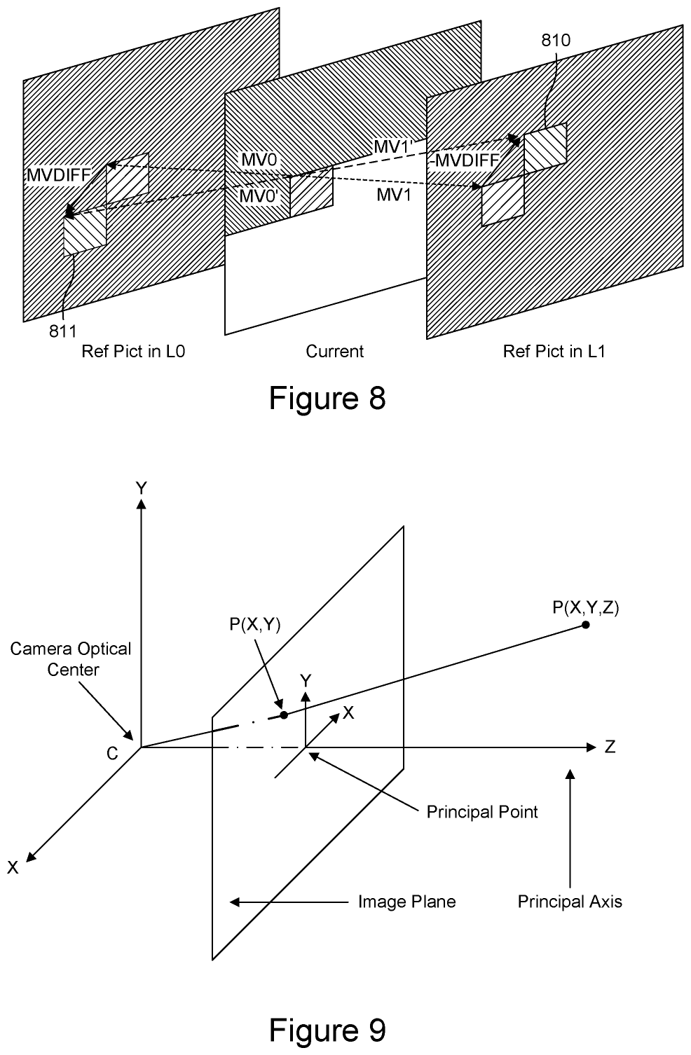

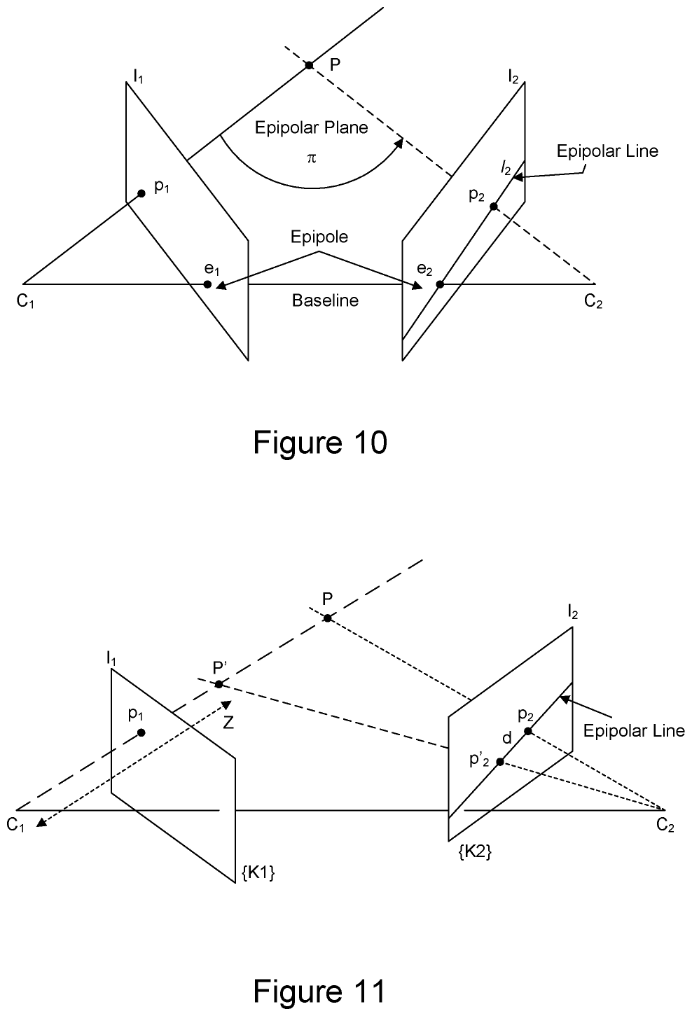

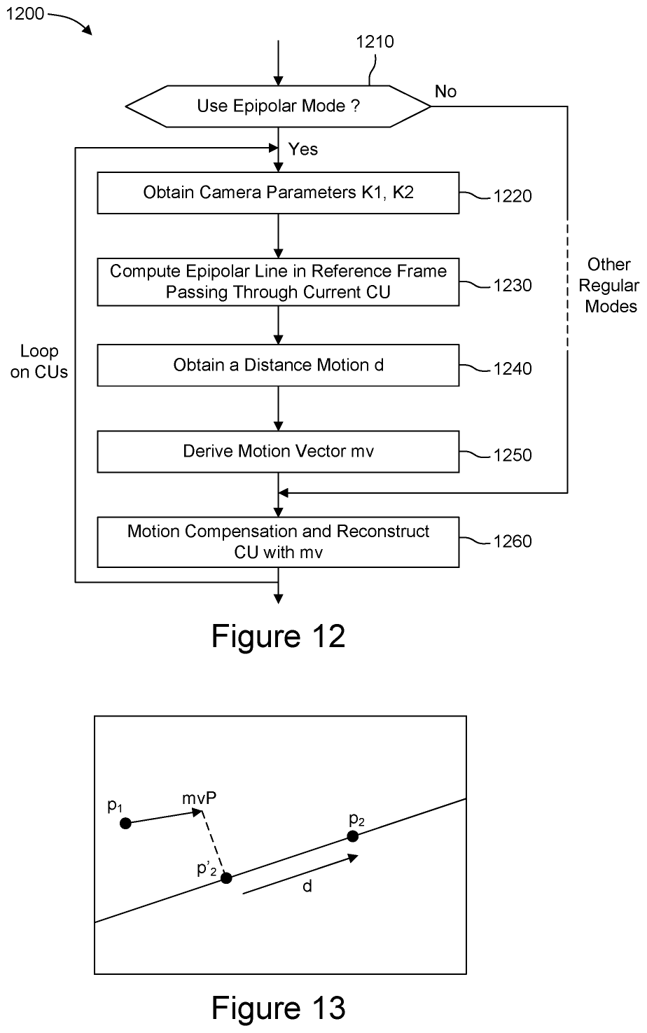

FIG. 12 illustrates an example flowchart to derive motion vector based on epipolar geometry according to at least one embodiment. This embodiment uses a motion predictor mvP (ex: motion vector from neighboring reconstructed CU or co-located motion vector) projected onto the epipolar line to determine p′2 as shown in FIG. 13. The projection direction can be perpendicular to the epipolar line for instance.

The flowchart 1200 is described in the context of a decoder device, for example as implemented by a processor 1010 or a decoder 1030 of a decoder device 200. In step 1210, the use of epipolar mode (i.e. using the epipolar geometry constraint) is tested, for example by testing a flag or any information representative of an epipolar mode in the bitstream to be decoded. If this mode is not used, then a conventional mode is used to determine the motion vector mv. When the epipolar mode is used, in step 1220, the fundamental matrix or the camera parameters K1 and K2 of respectively current frame and reference frame are obtained. These parameters are for example carried in high-level syntax elements as parameters of the frames or may be obtained by other means. Then, in step 1230, the epipolar line is computed as the line in the reference frame passing through the current coding unit (for example going through current CU center or top left sample of the current CU). In step 1240, a distance parameter “d” onto the epipolar line is obtained, for example extracted from information representative of the distance parameter in the bitstream. The corresponding motion vector mv is then determined in step 1250, and comprises two values for respectively the horizontal and the vertical directions. Finally, the motion compensation can be performed in step 1260 to reconstruct the CU using the motion vector mv and the reference frame.

This method may be implemented in a regular codec as a coding mode in inter (320) or used to build an additional motion vector predictor for the AMVP or merge motion vector candidates list. This model assumes that the point P in the scene is not moving and that the relative motion of P in frames 1 and 2 is only caused by the camera motion.

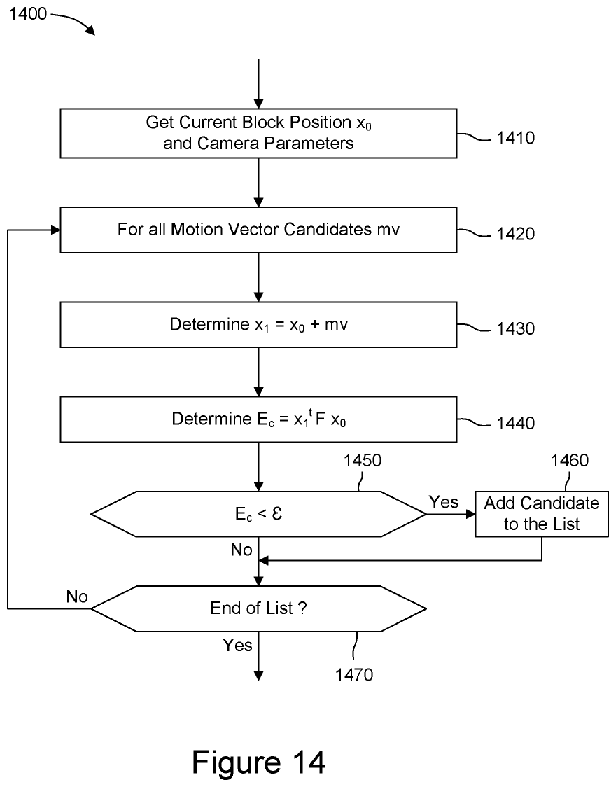

FIG. 14 illustrates an example flowchart of merge candidates filtering process according to at least one embodiment. Indeed, in at least one embodiment, instead of encoding the motion vector using the epipolar geometry constraint, the epipolar geometry is used to constrain the potential predictor candidates. In merge mode, as introduced above, a list of candidates is computed from spatial, temporal and history-based motion vectors. The list is filled up to N candidates (typically N=5) and an index indicating the candidate to be used is transmitted. During the list creation, some candidates are not inserted in the list (typically, when the candidate is not available or when an identical motion information is already present). In this embodiment, it is proposed to filter the potential candidates by adding to the list of candidates only the candidates respecting the epipolar geometry constraint, up to a threshold. Recalling that from the fundamental matrix F (which may be computed from the camera parameters K1 and K2 or provided to the decoder by other means), the epipolar constraint is expressed as x₁^{t}Fx₀=0 where x₀ is the block coordinate in projective coordinate in the current frame and x₁=x₀+mv is the corresponding block in the reference image, where mv is the motion vector of the block. The constraint can be relaxed using a given threshold ε as |x₁^{t}Fx₀|<ε.

The merge candidates filtering process takes place only when the epipolar mode is activated. This mode is signaled either at block level, CTU level or frame level. This process is for example executed by a processor 1010 or an encoder 1030 of an encoder device 100. In step 1410, the current block coordinate position x is obtained. The block coordinate position is taken from a pre-determined position in the CU, the top-left corner for example. Also the camera parameters are obtained. In a variant embodiment, the pre-determined position in the CU is the block center. Then, from step 1420 to step 1470, the process iterates on motion vector candidates mv and, for each potential candidate, the corresponding block coordinate position in the reference image is computed from the motion vector. In step 1430 it determines x₁=x₀+mv, and in step 1440 determines the epipolar constraint E_{c}=x₁^{t}Fx₀ based on the camera (fundamental matrix) parameters. In step 1450, this value E_{c} is compared to the threshold ε. If lower, it means that this candidate respects the epipolar geometry constraint and this candidate is added to the list of merge candidates in step 1460. If higher or equal, the constraint is not respected, and the candidate is not added to the list. In step 1470, it is verified that all motion vector candidates have been tested.

A similar candidate filtering process can be implemented for the AMVP motion vector predictor list, based on the same logic.

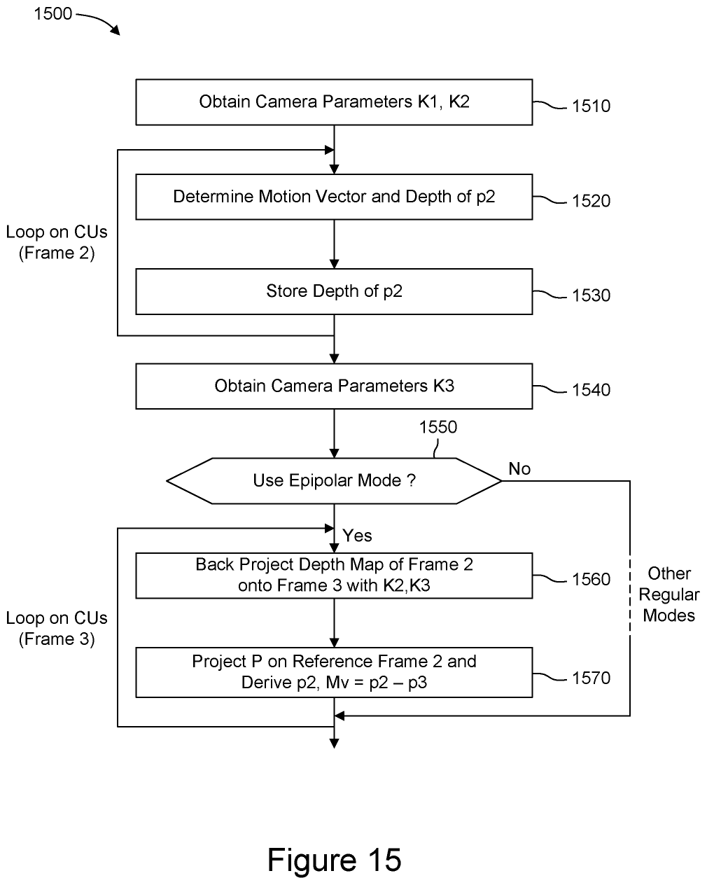

FIG. 15 illustrates an example flowchart for the derivation of motion predictor from stored motion info according to at least one embodiment. This embodiment considers the case where the current CU has been reconstructed and aims at deriving the motion predictor from motion information previously stored. In other words, the point p2 has been derived from p1 plus the derived motion vector, where the process for deriving the motion vector may have followed regular inter-prediction (such as the ones defined in HEVC or VVC) or the method depicted above. The motion vector may be stored in the motion info buffer to be used as “co-located” motion vector for decoding a next frame (frame 3). The absolute position of P in the scene (or the depth of P in frames 1 and 2 which is equivalent) can be derived from the set of points p1, p2 and the camera parameters K1, K2 (or the fundamental matrix). For the subsequent frames, such as frame 3 with camera parameters K3, P can be projected into frame 3 to be used as prediction to frame 3. P is associated with pixel p1 in frame 1 and with pixel p2 in frame 2.

In a variant, since the depth of P in frame 1 and in frame 2 is known, one can build the depth map for frame 3 with camera parameters K3. This can be done in two steps: first, build the depth map for frame 2 during the reconstruction/decoding of frame 2 using the epipolar principle, second, derive depth map for frame 3 from depth map of frame 2 using K2 and K3 parameters. Advantageously, the depth map can be stored in the motion info buffer with the regular motion vectors used to reconstruct the CUs. In a variant, this can be done “on-the-fly” for all CUs in frame 3. For a given current CU in frame 3 situated at position p3 in the frame 3 (for example p3 can be the center of the CU), the motion vector stored in the motion info after reconstruction of frame 2 and the camera parameters (K1,K2) may be used to derive P or the depth of the current CU in frame 2. Then, the back projection of P in frame 2 with the camera parameters K2 can be used to derive p2, next the motion vector predictor is mv=p2−p3.

The process 1500 is now described here in the context of a decoder device, for example as implemented by a processor 1010 or a decoder 1030 of a decoder device 200. In step 1510, the camera parameters K1 and K2 of respectively the frame (frame 1) used as reference by frame 2 and the reference frame for current frame 3 are obtained. In step 1520, a motion vector and the depth of p2 are determined. In step 1530, the depth of p2 is stored. Steps 1520 and 1530 are iterated for all the CU of frame 2. Then, in step 1540, camera parameters K3 of next frame (frame 3) are obtained and the use of epipolar mode (i.e. using the epipolar geometry constraint) is tested as previously mentioned. If this mode is not used, then a conventional mode is used to determine the motion vector mv. In step 1550 it is determined whether the epipolar mode is used. When the epipolar mode is used, in step 1560, the depth map of frame 2 is back projected onto frame 3 using K2 and K3 parameters. Finally, in step 1570, P is projected on reference frame 2, p2 is determined as well as the motion vector mv=p2−p3. Step 1550 is implemented in an encoder by testing a flag set during the RDO loop when testing all encoding possibilities. In a decoder, this flag is signaled in the encoded bitstream.

This process may be implemented in a regular codec as a coding mode in inter or used to build an additional motion vector predictor for the AMVP or merge motion vector candidates list, or for the filtering the motion vector candidates list as explained above. Similarly, than before, this method assumes the point P in the scene is not moving and that the relative motion of P in frames 1, 2 and 3 is only caused by the camera motion.

In at least one embodiment, it is proposed to define a new epipolar affine mode derived from the regular affine motion prediction mode, where the regular affine motion vectors used as control points are adapted to follow the epipolar constraint as expressed in the first embodiment. This constraint would be that the control points motion vectors (CPMV) should be on the epipolar line going through the control points location. The adaptation may comprise one of the following:
the projection of the CPMV on the epipolar line, for example as described in the process 1200 of FIG. 2,
the selection of the CPMV from the MV merge candidates is based on a filtering of MV candidates, for example as described in the process 1200 of FIG. 12,
the CPMV may be not epipolar but the derived sub-blocks are adapted to be epipolar.

In at least one embodiment, it is proposed to define a new epipolar MMVD mode derived from the regular MMVD mode. The epipolar geometry constraint can be used to redefine the two index tables of this MMVD coding mode. For example, one may filter (remove) from the table the indexes corresponding to motion vectors not respecting the epipolar geometry constraint similar to the process 1200 of FIG. 12, or to modify/adapt the motion vector candidates similar to the epipolar affine mode.

In at least one embodiment, it is proposed to define a new epipolar SMVD mode derived from the regular SMVD mode. In one embodiment, only one value is coded for coding MVD0 for example as described in the process 1200 of FIG. 12. In a variant embodiment, the value of the reconstructed motion vector (MV0=MVP+MVD0) is modified/adapted so that the reconstructed motion vector respects the epipolar geometry constraint, as for example described above for the new epipolar affine mode. In another variant embodiment, the list of motion vector candidates for deriving MVP is modified or filtered into MVP′ for example as described in the process 1400 of FIG. 14.

In addition, the principles of the new epipolar SMVD mode may be applied to the “symmetrical” vector introduce above and where MV1=MVP−MVD0. In a variant, MV1 is derived as directly as MV1=MVP′−MVD0, with MVP′ computed for example as described in the process 1400 of FIG. 14.

In at least one embodiment, it is proposed to adapt the motion vector refinement (DMVR) process. In the regular DMVR mode, the search process evaluates all the integer positions in a window around the original motion vectors and retain the ones with minimal SAD. The final sub-pel motion vector is derived by minimizing a 2-D parabolic error surface equation. In one embodiment, such DMVR process is modified similarly to the new epipolar affine mode so that the tested motion vector pairs follow the epipolar geometry constraint. In a variant, the DMVR refinement process is not modified except the final motion vector which is modified similarly.

All these proposed modes may co-exist with the regular modes. In this case, they are explicitly signaled for example by using a new flag at the CU level or may be inherited at the CU level such as in the merge case. The proposed modes may also replace the corresponding regular mode. In this case, a flag is coded in the High-Level Syntax, for example at the slice level or at picture level (in the picture headers).

In addition to these flags, the camera parameters or the fundamental matrix associated with one reference frame for a current frame using an epipolar mode as proposed in the embodiments above also need to be conveyed. In other words, these parameters need to be encoded within the encoded video bitstream. This can be done for example by corresponding High-Level Syntax elements, added for example for each frame, at slice level or at picture level. In at least one embodiment, when camera parameters did not change from one frame to the next frame, the parameters are not transmitted, thus saving some bandwidth.

Advantageously, the camera parameters values or the fundamental matrices angles or coefficients may be predicted from previous camera parameters or fundamental matrices, then only difference values may be transmitted.

Example of syntax for carrying camera parameters is found in table 3.

TABLE 3

| | Descriptor |
|---|---|
| camera_parameters ( ) { | |
| extrinsic_camera_parameters ( ) { | |
| Rotation_angle_1 | se(v) |
| Rotation_angle_2 | se(v) |
| Rotation_angle_3 | se(v) |
| Translation_x | se(v) |
| Translation_y | se(v) |
| Translation_z | se(v) |
| } | |
| intrinsic_camera_parameters ( ) { | |
| focal | se(v) |
| pixel ratio | se(v) |
| skew | se(v) |
| } | |
| } | |

Example of syntax for carrying a fundamental matrix is found in table 4.

TABLE 4

| | Descriptor |
|---|---|
| Fundamental matrix ( ) { | |
| for ( i=0 ; i<9 ; i++ ) | |
| f[i] | se(v) |
| } | |

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, moving the information, copying the information, calculating the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory or optical media storage). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options

(A and C) only, or the selection of the second and third listed options (B and C) only, or the selection of all three options (A and B and C). This may be extended, as readily apparent by one of ordinary skill in this and related arts, for as many items listed.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

According to a variant of first or third aspect, the method or apparatus further comprises obtaining an information representative of the use of an epipolar mode and responsively obtaining first camera parameters of a current frame and second camera parameters of a reference frame, determining an epipolar line in the reference frame passing through a current block of the current frame, based on the obtained camera parameters, obtaining a distance motion, and determining a motion vector based on the distance motion and the epipolar line, and reconstructing the current block using motion compensation based on the determined motion vector.

According to a variant of first or third aspect, the method or apparatus further comprises obtaining first camera parameters of a current frame and second camera parameters of a reference frame, for a motion vector candidate, determining an epipolar constraint based on the obtained camera parameters and the position of the block, if the epipolar constraint is lower than a threshold, adding the candidate to the list of candidates and reconstructing the current block using motion compensation based on a candidate of the list.

According to a variant of first or third aspect, the method or apparatus further comprises obtaining first camera parameters of a previous frame, second camera parameters of a reference frame, and third camera parameters of a current frame, obtaining an information representative of the use of an epipolar mode and responsively determining depth map of previous frame with current motion vector stored in motion info buffer using first and second camera parameters, obtaining current depth map by back projecting depth map of previous frame onto current frame based on the first and third camera parameters and a stored depth map for previous frame, determining motion vector based on current block position and current depth map using second and third camera parameters, and reconstructing the current block using motion compensation based on the determined motion vector.

According to a variant of second or fourth aspect, the method or apparatus further comprises obtaining first camera parameters of a current frame and second camera parameters of a reference frame, determining an epipolar line in the reference frame passing through a current block of the current frame, based on the obtained camera parameters, obtaining a distance motion, determining a motion vector based on the distance motion and the epipolar line and reconstructing the current block using motion compensation based on the motion vector, and encoding at least an information representative of the use of an epipolar mode, first camera parameters of a current frame and second camera parameters of a reference frame.

According to a variant of second or fourth aspect, the method or apparatus further comprises obtaining first camera parameters of a current frame and second camera parameters of a reference frame, for a motion vector candidate, determining an epipolar constraint based on the obtained camera parameters and the position of the block, if the epipolar constraint is lower than a threshold, adding the candidate to the list of candidates, and encoding at least an information representative of the use of an epipolar mode, first camera parameters of a current frame and second camera parameters of a reference frame.

According to a variant of second or fourth aspect, the method or apparatus further comprises obtaining first camera parameters of a previous frame, second camera parameters of a reference frame, and third camera parameters of a current frame, obtaining an information representative of the use of an epipolar mode and responsively determining depth map of previous frame with current motion vector stored in motion info buffer using first and second camera parameters, obtaining current depth map by back projecting depth map of previous frame onto current frame based on the first and third camera parameters and a stored depth map for previous frame, and determining motion vector based on current block position and current depth map using second and third camera parameters, reconstructing the current block using motion compensation based on the determined motion vector, and encoding at least an information representative of the use of an epipolar mode, first camera parameters of a current frame and second camera parameters of a reference frame.

1-18. (canceled)

19. A method comprising:
obtaining an information representative of the use of an epipolar mode for a current block of a current frame of a video and responsively:
obtaining first camera parameters of a current frame and second camera parameters of a reference frame;
determining an epipolar line in the reference frame passing through the current block of the current frame, based on the obtained camera parameters;
obtaining a distance motion on the epipolar line;
determining a motion vector based on the distance motion and the epipolar line; and
reconstructing the current block using motion compensation between the current block of the current frame and a block of the reference frame based on the determined motion vector.

20. A method comprising:
obtaining first camera parameters of a current frame and second camera parameters of a reference frame;
determining an epipolar line in the reference frame passing through a current block of the current frame, based on the obtained camera parameters;
obtaining a distance motion on the epipolar line;
determining a motion vector based on the distance motion and the epipolar line;
reconstructing the current block using motion compensation between the current block of the current frame and the block of the reference frame based on the motion vector; and
encoding, for the current block of the current frame, at least an information representative of the use of an epipolar mode, first camera parameters of a current frame and second camera parameters of a reference frame.

21. An apparatus comprising a decoder for decoding a block of pixels of a current frame of a video, the decoder being configured to:
obtain an information representative of the use of an epipolar mode for a current block of a current frame of a video and responsively:
obtain first camera parameters of a current frame and second camera parameters of a reference frame;
determine an epipolar line in the reference frame passing through the current block of the current frame, based on the obtained camera parameters;
obtain a distance motion;
determine a motion vector based on the distance motion and the epipolar line; and
reconstruct the current block using motion compensation between the current block of the current frame and a block of the reference frame based on the determined motion vector.

22. An apparatus comprising an encoder for encoding a block of pixels of a current frame of a video, the encoder being configured to:
obtain first camera parameters of a current frame and second camera parameters of a reference frame;
determine an epipolar line in the reference frame passing through a current block of the current frame, based on the obtained camera parameters;
obtain a distance motion on the epipolar line;
determine a motion vector based on the distance motion and the epipolar line;
reconstruct the current block using motion compensation between the current block of the current frame and the block of the reference frame based on the motion vector; and
encode, for the current block of the current frame, at least an information representative of the use of an epipolar mode, first camera parameters of a current frame and second camera parameters of a reference frame.

23. A non-transitory computer-readable storage medium having stored instructions that, when executed by a processor, cause the processor to:
obtain an information representative of the use of an epipolar mode for a current block of a current frame of a video and responsively:
obtain first camera parameters of a current frame and second camera parameters of a reference frame;
determine an epipolar line in the reference frame passing through the current block of the current frame, based on the obtained camera parameters;
obtain a distance motion;
determine a motion vector based on the distance motion and the epipolar line; and
reconstruct the current block using motion compensation between the current block of the current frame and a block of the reference frame based on the determined motion vector.

24. A non-transitory computer-readable storage medium having stored instructions that, when executed by a processor, cause the processor to:
obtain first camera parameters of a current frame and second camera parameters of a reference frame;
determine an epipolar line in the reference frame passing through a current block of the current frame, based on the obtained camera parameters;
obtain a distance motion on the epipolar line;
determine a motion vector based on the distance motion and the epipolar line;
reconstruct the current block using motion compensation between the current block of the current frame and the block of the reference frame based on the motion vector; and
encode, for the current block of the current frame, at least an information representative of the use of an epipolar mode, first camera parameters of a current frame and second camera parameters of a reference frame.
